(19) United States
(12) Patent Application Publication
(10) Pub. No.: US 2011/0229605 A1
(43) Pub. Date: Sep. 22, 2011

(54) WHOLE FISH PRODUCTS AND METHODS OF MAKING AND USING THEM

(76) Inventor: Louis Augustus George Atteck, Vienna (AT)

(21) Appl. No.: 12/998,701

(22) PCT Filed: Nov. 23, 2009
(86) PCT No.: PCT/AT2009/000455

§ 371 Date: May 20, 2011

(30) Foreign Application Priority Data
Dec. 1, 2008 (GB) GB0821896.8

(51) Int. Cl. A23L 1/325

(52) U.S. Cl. 426/61; 426/574

(57) ABSTRACT

Whole Fish composite Products made from a dry Structural Component and a Fish Meat Powder that has retained most of functional properties and which can both be reconstituted with water and mixed together to produce a range of products.

### BACKGROUND OF THE INVENTION

The Invention relates to a Method for making Fish Meat Products that includes a Whole Fish Product made from Whole Fish or other marine animals in which a substantial portion of the available Meat from the eviscerated Fish Carcass is separated out and Solubilised and the residual meat, skin and bones are then hygienically processed separately. When the result of these processes are recombined into its original proportions and cooked, the resultant Whole Fish product has retained most of the organoleptic properties and functional attributes of cooked fresh Fish. It is known to produce a soluble protein material from fish meat by hydrolysis and to dry the resulting liquid to produce a powder. Such a powder is soluble in water but has lost most of its functional properties such as heat gellability at 50 deg C., emulsifying ability, thixotropy, and water holding capacity. Another product that has similar properties comprises whole Fish Meal that has been cooked, dried and powdered under hygienic conditions and called fish protein concentrate (FPC B). It is also known to produce a soluble protein material from land animal muscle meat by solubilising the Actin and Myosin that are the main Muscle Contracting Components of meat while they are in their separate forms in the pre-rigor state in a salt and Polyphosphate or salt only solution and drying it to produce a dry meat powder that has retained some of its functional properties (GB 2,060,644, EP 0064104, CP 1197236 and U.S. Pat. No. 4,406,831).

Solubilisation of pre-rigor land animal muscle meats such as beef and pork and its applications has so far been accomplished only to a limited extent using the patents cited.

### The Problems Discovered Since

The problem is that the processes described in these Patents have since been found to be highly dependent on processing the meat well before the process of rigor mortis starts and the oxygen reserves in the muscle is progressively depleted and which results in the muscle components actin and myosin combining to form acto-myosin which is not able to be solubilised using salt (sodium chloride) alone. Although it is possible to form a thick slurry by addition of Polyphosphates, which is considered a food additive, to the salt to produce a viscous material that includes swollen meat particles, that has limited functional properties.

Additionally in the application of the above patents using salt only, the presence of increasing quantities of Acto-Myosin and finely chopped meat muscle pieces as the meat goes into rigor, tends to absorb a substantial portion of the salt solution by diffusion, leaving insufficient salt solution to carry out the optimum solubilisation of the individual Actin and Myosin molecules. The presence of the Acto-Myosin and the swollen meat pieces results in lower functionality of the combined material and increased viscosity of the mixture. This viscosity affected the throughput of material that can be handled by the Spray Dryer and which together with the larger diameter droplet size produced at the Spraying Head results in a lowering of the efficiency of the Process by keeping the residence time of the droplets at a higher temperature allowing some denaturation to take place thus lowering the yield of the desirable soluble protein component.

Furthermore if drying or freezing is not used relatively quickly to stabilise the solubilised actin and myosin molecules they slowly aggregate to mainly actomyosin and forming a stiff gel, losing a considerable proportion of the desired functionality. The presence of Polyphosphates acts to help prevent this happening by probably raising the pH.

In practice, because of slaughter house regulations and the whole procedure to produce carcass meats, time has been sacrificed to the extent that it sometimes takes more than 30-60 minutes before deboning starts. This together with the variable pH of the starting material due to the presence of variable oxygen reserves that affects the initiation of anaerobic glycolysis in which Adenosine Diphosphate is converted to Adenosine Triphosphate by glycolysis of Glycogen and resulting in the production of variable quantities of Lactic Acid within the muscle at the time of death causing the pH to fall, adds to variations in the complex process of rigor-mortis.

### Solution

Ideally the key to maximum solubility resides in keeping any type of land or marine animals in a stress-less environment for as long as possible before death and before Rigor Mortis starts and in the case of fish, in its watery environment, such that the oxygen reserves are at its highest and the formation of lactic acid is minimal and the muscle has a normal pH value. Under these conditions, the Myofibrillar and Sarcoplasmic proteins which are the main muscle proteins, can be optimally solubilised using Sodium Chloride brines only, resulting in a product with excellent functional properties that includes strong heat gellability between 37 deg C. for the sarcoplasmic and 50 deg.C. for the myofibrillar proteins, emulsifying power, thixotropy and water holding capacity, and which when cooked slowly hardens to form a three dimensional structure with desirable rheological attributes and excellent organoleptic properties. The Solubilised Meat slurry is quite liquid at this stage but it is unstable as it slowly converts to Actomyosin and the viscosity increases as it loses a substantial portion of these desirable properties and it is essential to make Products such as restructured Analogues and Semi-Analogues as soon as possible to take full advantage of its binding properties. However the Solubilised Meat slurry can be stabilised for a considerable time by either Quick Freezing or Spray Drying.

### RATIONALE OF THE INVENTION

It is now been possible to focus on marine animals by creating a system that allows the solubilisation process to be completed well before the onset of Rigor Mortis for Fish which was not possible for land animals, and using only salt solution to achieve the end.

Any type of Fish and Marine animals such as Krill were never a target for the solubilisation process of the previous patents, as traditionally it is almost impractical to have the raw material in the pre-rigor state as fish go into rigor within 15 to 30 minutes of death, compared to over 1 hour for land animals, as they die from the lack of oxygen which is stressful and in any case due to the method of fishing, a large portion are already dead and in rigor when the net is hauled on deck. The Invention can be applied to any kind of Animals or Fish and preferably concentrates on cheap pelagic fish which are generally oily and difficult to process but which is utilised mainly to produce Fish meal and Fish oil which is rich in omega oils which is very desirable. The Solubilised meat protein has very high emulsifying properties over that of fresh meat due to the stabilised free actin and myosin molecules and when used in Products stabilises the oils by emulsification which locks it within the product to produce improved organoleptic properties and mouth feel when eaten. When dealing with dried products there is a further complication in that the solubilised meat has enhanced water holding capacity so that if more of the required water of rehydration is added, it holds on to it making it unavailable for rehydrating the other dry components. This can be overcome by initially rehydrating the components separately with the required amount of water before recombination. The more concentrated the solubilised material solution is, a stronger bond is produced when cooked

### THE INVENTION

Whole Fish Products and Methods for Producing, Stabilising and Using them comprises in combination;
methods for Producing the whole fish Products that include, in combination, methods of Fishing that feeds live Fish to a De-Gutting process with a minimum of stress and then the de-gutted Fish is quickly de-boned to produce Fish Flesh in its earliest Pre-Rigor state and a Residue comprising residual Flesh, Skin and Bones and then the Pre-Rigor Fish Flesh portion is immediately solubilised by Comminution in a Salt (Sodium Chloride) solution to produce a Solubilised Fish Flesh Product;
methods for stabilising the solubilised Fish Flesh product by immediately drying it in Powder Form by any suitable Means that includes Spray Drying or by Freezing it;
methods for stabilising the Residue components using Suitable Drying Means that includes Grinding and Drying and Granulating to produce a coarse particulate material;
methods for reconstituting the Dry Meat Powder and the Residue Powder separately with water and then mixing the resulting mixtures in various combinations to make Whole Fish Products;
methods for packaging the Dry Powder and Dry Residue preferably in separate packs by any suitable Means that makes it easy to distribute and which ensures a Long Shelf Life;
and methods for extending the Product Range by substitution of the Residue with any suitable Meat Protein or non-meat Protein Products to make Analogues and Semi-Analogues.

### PREFERRED EMBODIMENTS

The preferred embodiments of the Invention describes, a novel system not taught by the prior art which together with the disclosures herein, comprises the inventive step that describes a system of discrete operations, in combination, which includes the animals being delivered to the process within a very short space of time while still alive. Without prior knowledge of these disclosures no one would have considered inventing the system proposed here.

### Fishing and De-Gutting

The Prior Art teaches that Pelagic and other shoaling small-value Fish and Marine Animals are traditionally caught by nets in the sea mainly by Seining at upper levels or Trawling at deeper levels dependent on where the target food is located. Because the animals are held in the nets for a long time before hauling on board, a substantial number are already dead and in Rigor Mortis. The fish are then held in bulk storage before transferring to shore factories or to a mother ship for processing mainly by drying and grinding to produce Fish Meal.

The invention teaches that in both methods using a factory vessel, the vessel is modified to utilise both the hydro-static pressure of the water and/or a Syphon system to cause the water within the nets to flow into the vessel to transport the fish in their natural environment with minimal stress directly to the processing equipment. The proposed method of fishing also enables fishing in any weather conditions to be carried out 24 hours a day, using the latest technologies such as radar, Sonar and global positioning etc.

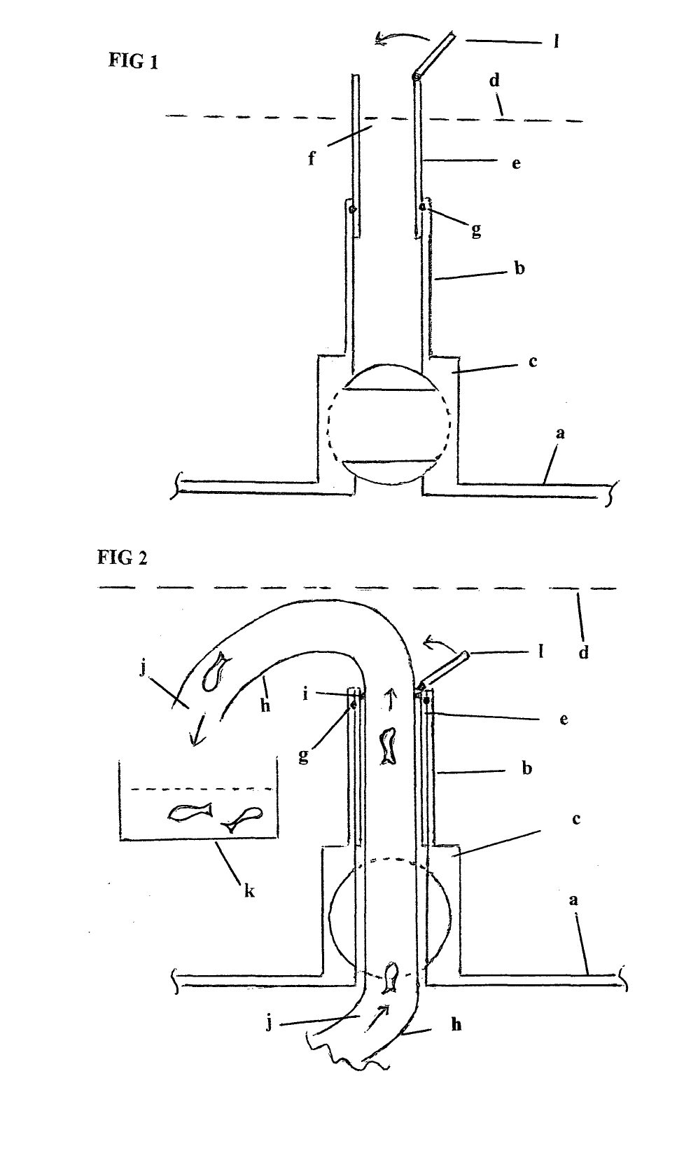

The vessel has a hole built into any suitable position in its Hull FIG. 1. (a) that is situated to facilitate Trawling and Seining modes and one preferred position in its hull about its centre of flotation, which is the position least affected by upward and downward movements due to wave action and which tends to put a strain on the umbilically connected tube referred to later. A substantial robust rigid tube of a suitable diameter (b) is substantially attached over the hole, and which has an easy to operate substantial fail safe valve (c) (such as a ball cock) at its base and which rises vertically to a suitable height below the sea water level (d). The robust rigid tube has a movable inner rigid tube (e) that has means to move it telescopically within the outer rigid tube, and which can effectively extend or shorten the combined tubes to extend above the waterline (f) and which contains suitable sealing means (g) to prevent water seeping between the tubes and additionally has a capping means (l) to seal it from the sea outside. When the inner tube is lowered so that its upper end is below the waterline, sea water can flow into the vessel. When not in use or in an emergency, the ball valve is closed and the inner tube can be raised above the waterline and capped securely.

When in use FIG. 2, the cap (l) is removed and the ball valve is opened and a smaller diameter flexible tube (h) comprising many similar tubes that are easily joined together by suitable means to achieve a suitable length is lowered through the inner tube to the outside of the vessel such that if its outer leading end is initially capped it floats up to the side of the vessel when a collecting cone is attached to the end. The inner tube end also has sealing means (i) such that when the telescopic tube and flexible tub are lowered below the waterline, water flows only through the flexible tube and the sea water containing the fish (j) can be directed to a holding tank (k) that keeps the fish alive for the processing stage.

Another preferred method used is to position a hole with a solid Tube and Valve at a suitable point in the hull on one side of the vessel just above the waterline with sealing means that allows a flexible tube to pass through it such that the outside end is within the pool of fish in the Seining Mode and the inner end is at a much lower level and if the outer and inner ends are sealed and the tube has means to be filled with water to prime the syphon system created, when the sealed ends are opened, water flows into the vessel.

In the Purse seining mode, the seine is set, either by the factory vessel or smaller catching vessels that are not required to collect and store the fish but to carry multiple sets of seines. When a shoal or collection of fish is detected the net is set to surround the fish and the purse is drawn to imprison the fish within the seine and the catcher can move on to detect and catch other shoals of fish. The Seine is marked such that it is visible to the factory vessel which can then come alongside the seine and draw in the net to concentrate the fish so that when the cone at the end of the flexible tube in any mode is placed within the trapped fish and the inner tube is lowered below water level, the fish are carried with the water into the holding tank. Means is provided to pump excess water out of the vessel,

In the trawling mode Two vessels in tandem are used, in which the leading vessel is merely a tug boat that has the ability to set the trawl and has means to keep a constant distance between the two vessels. The trawl is modified at the Cod End by fitting a non-flexible cone of suitable size to prevent compressing the trapped animals which in the case of Krill are soft and easily damaged as the net moves forward and which has means to be attached to the flexible tube that exits the factory vessel which is long enough to allow the trawl to be used normally and has enough length to connect the vessels. The Cod End and the factory vessel are thus umbilically connected and fish entering the Cod End can be transferred as required to the holding tank of the processing means. When required for the first processing stage the fish are de-gutted and washed using standard equipment used in the industry or alternatively in the case of Krill, degutting may be carried out centrifugally. These two fishing modes described are easily interchangeable as in certain instances due to environmental conditions, the Phytoplankton on which the fish feed, may migrate to lower depths such that Trawling may be required.

Separating the Meat from the De-Gutted Fish

The Pre-rigor degutted fish are fed to any commercial machine such as made by Baader, preferably after cutting into pieces, that separates the flesh from the skin and bones.

One preferred system uses a modified Bone Press such as that used for land animals that applies pressure to the de-gutted fish in the cylinder chamber that contains fine holes that allows only the softer meat to pass through the fine holes in the cylinder walls but retains the other solids. The Invention modifies this system by fitting volumetric stops to the shaft of the piston that applies the pressure in the cylinder, such that for a fixed weight of Fish in the Cylinder Chamber, the first stop separates only the predetermined amount of flesh that is bone free, that is to be be used for the solubilisation batch process and other stops can eventually result in only the bones. The ratio of the amount of flesh separated to the residue can vary between the maximum of available flesh to any amount that is required to produce the right mixture for the product based on its texture required by the recipe, such as when making fresh frozen fish meat products etc. The Residue that in some cases includes the remainder of the available flesh and skin and bones can be ejected and dried together in a hygienic Fish Meal Plant. If only the Bones are left by applying full pressure to press out the skin, it can be pressure cooked to soften them or bulked with the first stop residue material for the Fish Meal Drying stage.

The ideal situation is therefore to feed the required batch amount of flesh to the solubilisation process at the optimum feed rate which may constitute multiples of comminution machines.

### Solubilisation

The Pre-rigor Fish meat is solubilised in a high speed multi-knife Bowl Chopper at speeds over 5000 revs per minute or any other commercial high-speed comminution system that quickly disintegrates the flesh such that the surface of the fine particles is quickly in intimate contact with the Brine of suitable Sodium Chloride concentration to ensure maximum solubilisation. The Invention uses any suitable ratio of brine to meat and one preferred ratio is one part of a very cold Brine solution containing 8% w/w. Sodium Chloride to two parts by weight of the Pre-rigor Fish meat. The mixture is chopped to a thick liquid consistency for about 1-2 minutes with continuous hand mixing until the liquid feels tacky to the touch which is a sign that solubilisation is accomplished but not much longer as heat that causes denaturation of the protein is generated during chopping especially at the cutting edge of the knives so that cooling the brine is essential. The earlier that the meat is in the pre-rigor state, the easier it is to achieve maximum solubilisation and producing a more fluid mix. The material at this stage can be then Spray Dried or used directly for making fresh or frozen products.

### Drying the Solubilised Meat to Stabilise it

The solubilised meat slurry is immediately fed to a minimal capacity holding tank that holds a few minutes supply that has means to continually feed the material at the optimal rate to any Suitable Commercial Spray Dryer. The larger the dryer the more satisfactory is the result. The Dryer operates at an inlet temperature of about 200 deg C. which can vary dependent on the throughput of material and the water content, as the evaporation latent heat keeps the droplets at a relatively low temperature below the protein denaturation point. The high water content prevents heat denaturation of the droplets at the Spraying Head but as they dry out as they fall to the bottom, the amount of water available is lower and it becomes liable to be slightly denatured due to the higher temperatures within the chamber although the drier the Powder the more stable it is to heat. It is more efficient to dry the Powder to the point at which it is capable of being fed to a fluidised bed dryer operating at suitable temperatures to achieve the target water content of 5% in the dry product with minimal denaturation and maximum throughput of dry Powder

Processing the Residue from the Meat Separation Process to Stabilise it.

The Residue is the key element that contributes to the structure of the final cooked Product as it contains structural materials such as denatured meat fibre and pieces of skin and bones which together with the solubilised material forms a composite structure that is “meat like” when cooked. Some Products such as fish balls do not require specific structure and may be randomly structured with the residue more finely divided.

It is therefore a target of this procedure to design the structural component to accomplish the above requirement or ensure that the Residue including the skin, produces a fibrous element and bones are not too finely divided as to lose structural contribution for other Products such as the Analogues and semi Analogues described below.

The residual meat, skin and bones, are therefore subjected to a controlled grinding and drying regime such as to be found in hygienic commercial fish meal plants or preferably uses commercial continuous twin screw extruders that grind, compress and shear the material into finely divided suitably sized particles while generating heat to soften tough material and bones and to remove some of the moisture before it enters the Drying stage. In the case of pelagic fish the desirable oil separates out and can be either sold or recombined with the dry residue when it is ground. In some preferred Drying systems, oxygen is eliminated by using a superheated steam drum dryer and the time the oil is heated is shortened such that deterioration of the oil is minimised thus preventing rancid flavours while retaining a fish flavour. Alternatively because the Residue is processed quickly while it is still fresh, there is a small quantity of undesirable odours present and the drying process is carried out by any drying process up to a water content above the final target content without too much oil separation and then the residue which may contain any undesirable odours is subjected to an Oxygen-free Steam Deodorisation fluidised bed dryer process operating at 160-200 deg C. that removes most of the Fishy odours associated with commercially produced Fish Meal and concurrently brings the water level to the target figure of below 5 percent, for long shelf life.

### Reconstituting the Meat and Residue Powders and Making Products

The dry components including the oils in the right proportions for a whole fish product are first reconstituted by first soaking the residue component in the total required amount of preferably hot water to make a whole fish product and then mixing in the solubilised meat component and the dough produced is processed to orientate the structural component by any known system including extrusion through fine orifices or any other suitable orienting equipment. By aligning the structural material while shaping it, the product assumes a more meat-like mouth-feel when cooked and eaten. Hot water is preferred at this stage to ensure that the oil present does not interfere with the rehydration process but is emulsified by the soluble meat component. The solubilised Meat of the Invention can be used in its original liquid pre-dried state to make fresh products which can also be frozen. In this mode, the liquid solubilised product which comprises the cementing and emulsifying component can be mixed with the wet residue including any additional water or any other Suitable food Material that can provide the structural component in the fabrication of meat analogues and semi-analogues.

After mixing the two components in all cases, the dough is extruded through fine orifices or any other suitable orienting system, to align the structural material to produce a oriented product which can be shaped into any desirable form and which when they are cooked has the organoleptic properties and mouth-feel of fish meat. By actually creating a structural entity similar to animal muscle meat, in which the myofibrils are aligned in one direction with the whole structure held together by the connective tissue material and which when cooked holds the denatured myofibrils' together to produce the structure, gives the final product the organoleptic properties and mouth-feel of meat.

The Mouth-Feel of the cooked meat is dependent on the form of the structural material used and ranges from non-oriented fine particles such as for Meat balls, to pieces of Fish Flesh for restructured products and eventually to binding of whole filets of small fish.

In all cases, the Products can be presented in many stages for sale such as when the Products are heated, as the reach 50-60 deg C. the cementing component start to irreversibly gel, enabling the product to be handled and packaged without the stickiness, and eventually progressively hardens as the temperature rises to 60 deg C. and over, when denaturation reaches its maximum and the cooked product becomes meat like with excellent organoleptic properties including Mouth-Feel.

### Packaging

After drying, if the dry products are not required to be utilised immediately, the Powder is vulnerable to oxidation processes due in part to the presence of residual oil in the flesh. It is therefore ideal for the Solubilised Product and the Residue to be either packed quickly or temporarily stored preferably under an inert atmosphere in a cool environment.

In the Fresh/Frozen option, the oriented and shaped mixture comprising the Binder and the wet structural component including wet Mycoprotein (see below) are quick frozen or heated to 50-60 deg C. to gel it before cooling and all Products are packed as commercially done.

In the Dried version, the Two types of Powders comprising the Binder and the Structural component (including Myco proteins) are packed separately at predetermined amounts preferably in bulk or in small quantities in individual or twin packs that is made of material that is moisture and oxygen impermeable, in the form of a bubble pack under an inert gas atmosphere or vacuum packed.

### Analogues and Semi-Analogues of Meat or Fish

Some Analogues and Semi-Analogues of meat as produced today, to up-grade smaller pieces of animal meat, apply work on the smaller meat trimmings from the deboning process in the presence of Salt/Polyphosphate brines to extract some of the surface Acto-myosin which comprises the binder component and when the mixture is moulded and cooked the resulting shaped and restructured meat product has a discernable structure of whole meat from which it was derived and with the muscle of the meat pieces acting as the only structural component and with the binder holding it all together. In practice the binder produced is relatively weak and which on cooking, results in some breakup of the moulded product. Other non-meat binders such as Caseinates and those of vegetable origin has also been used in this context and if the binder when heated, solidifies at a different temperature to the meat, denaturation and shrinkage with exudation of liquid will take place at different times and together with the shear forces produced will cause breakup of the composite structure.

It is an essential aim of the Invention to take this much further using any type of Animal Muscle Meat or Fish Meats, by actually creating a structural entity similar to animal muscle meat, in which the myofibrils are aligned in one direction and the whole structure is held together by the connective tissue material intimately mixed and coated with the solubilised Binder Material, that is much stronger than the Acto-Myosin Binder described before, and which when cooked the whole structure denatures at the same rate that holds the denatured myofibrils together strongly to produce the structure that gives the product the organoleptic properties and mouth-feel of meat.

In one form of the Invention, other preferred types of Suitable Food Material comprise the residue comprising connective tissue from the defatting of minced animal fats or trimmed connective tissue or a vegetable derived filamentous material of sufficient length comprising the Mycelia derived from higher Fungi such as the edible Mushroom Polyporus Squamosus (PS64) or any other approved suitable Mycoprotein with suitably long Mycelia which will comprise the orientable structural component. Such a combination with the Soluble Fish or Meat Protein binder is ideal for feeding purposes and because they are both cheap to produce and because the Mycoprotein filaments have high protein content compared to cereals, it is able in combination with Fish, to boost the available world protein resource. Incidentally such a combination would also be considered suitable for vegetarians.

In the lower fungi such as Fusarium that is used for making Quorn, the product contains a high level of RNA that has to be reduced by heating, for use as a food ingredient, whereas the higher Fungi such as edible mushrooms has a low RNA level requires no further heat treatment.

Using the products of the various stages therefore gives us many optional permutations of Binder to Structure combinations in ratios that result in a Whole or Semi-Whole Fish compositions.

For Fresh/Frozen Fish products the combinations therefore include mixing the solubilised liquid material and the processed Residue before the drying stage or the solubilised material with any other approved structural food material.

For Dried Fish mixtures, the liquid solubilised meat and the residue are first dried to ensure long life and have to be reconstituted to its original form with water and then mixed before use. With Mycoprotein, this component can optionally be first dried for long life and has to be suitably reconstituted with water before mixing with the liquid or spray dried reconstituted Meat binder.

In all Products, the presence of the very high Myosin content ensures that any oils (some pelagic fish have high oil content) present in the both the solubilised material and the residue are strongly emulsified during the mixing process which together with the excellent heat gelling properties results in minimal cooking losses and excellent organoleptic properties.

Furthermore, the Solubilised Muscle Protein is also preferably applied in gel form as concentrated as possible and in some cases the Powdered form may be sprinkled on to the meat pieces in the mixer allowing the residual liquid on the surfaces to dissolve and dilute the Powder creating the strongest possible binding power. On forming the resultant mass into products and allowing the product to rest for a while, the high salt concentration in the binder, is slowly depleted by diffusion into the meat particles causing the gel to become unstable and set into a stiff mass. It can be further strengthened by heating the product to just over 40 degrees C. and before full denaturation occurs at cooking temperatures.

Additionally, if larger muscles, including that of land animals, are used it is essential that the muscles are oriented in one direction in the Product since when denaturation occurs on cooking, the muscle fibres and connective tissue shrink at different rates along their length causing breakup of the bonding and the structure. In the case of land animals where there is more connective tissue present, the connective tissue is preferably disrupted by mechanical means, using tenderisers with thin sharp knives instead of needles aligned to sever the collagen tissue by creating a multitude of cuts in the tissue to minimise shrinkage attributed to the connective tissue, which are eventually sealed back by mixing the muscles with the binder material.

Flow Sheet of the Continuous Whole Fish Powder Process.
Live Fish 4,260 kg
Feed continuously into the system and immediately
eviscerate (−30%) and wash carcass.
Pre-rigor Carcass 3000 kg
Bone Press to a fixed extrusion point to achieve a fixed ratio of
Meat/residue or any alternative equipment with similar outcome.

| Pre-rigor Fish muscle mince 500 kg | | Residue containing rest of the muscle, |
|---|---|---|
| (25% protein/75% moisture) | | the skin and the bones 2500 kg |
| | | (75% moisture) |
| Immediately solubilise in bowl chopper | | Residue may be pre-pressure cooked |
| or alternative equipment using 250 kg | | to soften the bones before grinding and |
| Brine containing 8% w/w. salt. | | drying or fed directly to the steam drier, |
| Composition of slurry | | if the bones can be softened. This part |
| Fish muscle protein | 125 kg | of the process is mainly post-rigor. |
| Water | 605 kg | |
| Salt | 20 kg | |
| | 750 kg | |

Drying Process

| | |
|---|---|
| Spray dry preferably within 15 minutes. | Feed continuously preferably in 1 hour. |
| Spray dryer must be operating | super heated steam drum dryer |
| continuously at ideal conditions. | (5% moisture) |
| (5% moisture) | |

Composition of dry whole fish components

| | | | | | |
|---|---|---|---|---|---|
| Fish protein | 125 | kg | Dry residue | 625 | kg |
| powder | | | | | |
| Water | 7.6 | kg (4.98%) | water | 31.25 | kg (5.01%) |
| Salt | 20 | kg | | | |
| | 152.6 | kg | | 656.25 | kg |

= 808.9 kg

| | |
|---|---|
| (18.9%) | (81.1%) |

Grams of each material in separate or dual packets
(equivalent to 12 gm dry fish powder for 1 child when mixed)

| | | | |
|---|---|---|---|
| 2.27 | gm | 9.73 | gm |

(Multiples of these Quantities May be Bulked Together for Convenience.)

Re-constitution (12 gm fish powder requires 3 times wt of water)

Add the contents of 1 unit quantity of the Dry Residue Structural component packet into 36 ml of preferably hot water and leave to soak and swell up. When the mix has cooled down below 30 deg C., add the contents of the Fish Protein Binder Powder packet while mixing in quickly to prevent lumping. (mix contains about 0.6-0.7% salt). The dough can be extruded or otherwise rolled out to orient the fibres and formed into products.

The resulting whole fish mixture can be either used alone for “Whole-fish” balls or fish fingers etc or with other materials and seasonings as required to make a range of fish products. The Powder can also be used directly as a binder for products made from both fish meat pieces or whole fillets of fish into larger shaped entities.

1) Whole Fish Products and Methods for Producing, Stabilising and Using them comprises in combination;
methods for Producing the whole fish Products that include, in combination, methods of Fishing that feeds live Fish to a De-Gutting process with a minimum of stress and then the de-gutted Fish is quickly de-boned to produce Fish Flesh in its earliest Pre-Rigor state and a Residue comprising residual Flesh, Skin and Bones and then the Pre-Rigor Fish Flesh portion is immediately solubilised by Comminution in a Salt (Sodium Chloride) solution to produce a Solubilised Fish Flesh Product;
methods for stabilising the solubilised Fish Flesh product by immediately drying it in Powder Form by any suitable Means that includes Spray Drying or by Freezing it;
methods for stabilising the Residue components using Suitable Drying Means that includes Grinding and Drying and Granulating to produce a coarse particulate material;
methods for reconstituting the Dry Meat Powder and the Residue Powder separately with water and then mixing the resulting mixtures in various combinations to make Whole Fish Products;
methods for packaging the Dry Powder and Dry Residue preferably in separate packs by any suitable Means that makes it easy to distribute and which ensures a Long Shelf Life;
and methods for extending the Product Range by substitution of the Residue with any suitable Meat Protein or non-meat Protein Products to make Analogues and Semi-Analogues.

2) Whole Fish Products and Methods for Producing, Stabilising and Using them as in claim 1. in which one preferred method of Fishing uses a factory vessel, that is modified to utilise both the hydro-static pressure of the water or a Syphon system during Trawling or Seining to cause the sea water to transport the fish as it flows into the vessel while in their natural environment with minimal stress directly to the processing equipment.

3) Whole Fish Products and Methods for Producing, Stabilising and Using them as in claim 2. in which the vessel has, built into a suitable position in its hull and which may preferably be below its centre of flotation, a substantial robust rigid tube of a suitable diameter that is substantially attached over a hole of suitable diameter in the hull and which has an easy to operate substantial fail safe valve (such as a ball cock) at its base and which rises vertically to a suitable height below the sea water level and alternatively this system may be installed in any other suitable position.

4) Whole Fish Products and Methods for Producing, Stabilising and Using them as in claim 3. in which the robust rigid tube has a movable inner rigid tube that has means to move it telescopically within the outer tube, and which can effectively extend or shorten the combined tubes to extend above the waterline and which contains suitable sealing means to prevent water seeping between the tubes and additionally has a capping means to seal it from the sea outside.

5) Whole Fish Products and Methods for Producing, Stabilising and Using them as in claim 4. in which the inner tube is lowered so that its upper end is below the waterline, and sea water can flow into the vessel and when not in use or in an emergency, the ball valve is closed and the inner tube can be raised above the waterline and capped securely.

6) Whole Fish Products and Methods for Producing, Stabilising and Using them as in claim 5. in which, the cap is removed and the ball valve is opened and a smaller diameter flexible tube comprising many similar tubes that are easily joined together by suitable means to achieve a suitable length is lowered through the Inner Tube to the outside of the vessel such that if its outer leading end is initially capped it floats up to the side of the vessel when a collecting cone is attached to the end.

7) Whole Fish Products and Methods for Producing, Stabilising and Using them as in claim 6. in which the Inner Tube end also has sealing means such that when the telescopic tube and flexible tub are lowered below the waterline, water flows only through the flexible tube and the sea water containing the fish can be directed to a holding tank that keeps the fish alive for the processing stage.

8) Whole Fish Products and Methods for Producing, Stabilising and Using them as in claim 7. in which in the trawling mode comprises the factory vessel and a smaller vessel which may also be used in the Seining Mode and the Two vessels are used in tandem, in which the leading vessel acts as a tug boat that has the ability to set the trawl and has means to keep a constant distance between the two vessels and the trawl is modified at the Cod End by fitting a non-flexible cone of suitable size to prevent compressing the trapped animals as the net moves forward and which has means to be attached to the flexible tube that exits the factory vessel which is long enough to allow the trawl to be used normally and has enough length to connect the vessels which are thus umbilically connected and fish entering the Cod End can be transferred as required to the holding tank of the processing means.

9) Whole Fish Products and Methods for Producing, Stabilising and Using them as in claim 8. in which a preferred method used in Purse Seining comprises a hole is created at a suitable point in the hull of the vessel just above the waterline with sealing means that allows a flexible tube to pass through it such that the outside end is within the pool of fish in the Seine and the inner end is at a much lower level and if the outer and inner ends are sealed and the tube has means to be filled with water to prime the syphon system created, when the sealed ends are opened, water containing fish flows into the vessel.

10) Whole Fish Products and Methods for Producing, Stabilising and Using them as in claims 8 and 9. in which in the Purse Seining mode, the seine is set, either by the factory vessel or smaller catching vessels that are not required to collect and store the fish but to carry multiple sets of seines and when a shoal or collection of fish is detected the net is set to surround the fish and the purse is drawn to imprison the fish within the seine and the catcher can move on to detect and catch other shoals of fish and the Seine is marked such that it is visible to the factory vessel which can then come alongside the seine and draw in the net to concentrate the fish so that when the cone at the end of the flexible tube in either mode is placed within the trapped fish and the inner tube is lowered below water level, the fish are carried with the water into the holding tank.

11) Whole Fish Products and Methods for Producing, Stabilising and Using them as in claim 1. in which the Pre-rigor fish are first de-gutted and fed to any commercial machine that separates the flesh from the skin and bones or is separated in a modified Bone Press such as that used for land animals that applies pressure on the de-gutted fish in the cylinder chamber that has fine holes that allows the softer meat to pass through the fine holes in the cylinder walls but retains the other solids and the Press may have stops to adjust the amount of meat required for the solubilisation process and the remainder can be used for fresh or frozen fish meat products and the Residue comprising residual flesh, skin and bones is sent for further processing.

12) Whole Fish Products and Methods for Producing, Stabilising and Using them as in claim 1. in which the early Pre-rigor Fish meat is solubilised in a high speed multi-knife Bowl Chopper at speeds over 5000 revs per minute or any other commercial high-speed comminution system that quickly disintegrates the flesh such that the Actin and Myosin molecules at the surface of the fine particles are quickly in intimate contact with Very Cold Brine of suitable Sodium Chloride concentration to ensure maximum solubilisation

13) Whole Fish Products and Methods for Producing, Stabilising and Using them as in claim 12. in which the ratio of brine to meat is any suitable ratio that uses the minimum percentage of Sodium Chloride to achieve maximum solubilisation using the minimum of Brine to Meat ratio and one preferred ratio is one part of a very cold Brine solution containing 8% w/w. Sodium Chloride to two parts by weight of the Pre-rigor Fish meat.

14) Whole Fish Products and Methods for Producing, Stabilising and Using them as in claims 12 and 13, in which the mixture is chopped to a thick liquid consistency Slurry for about 1-2 minutes with continuous hand mixing until the liquid feels tacky to the touch which is a sign that solubilisation is accomplished but not much longer as heat that causes denaturation of the protein is generated during chopping especially at the cutting edge of the knives so that cooling the brine is essential.

15) Whole Fish Products and Methods for Producing, Stabilising and Using them as in claim 1. in which the solubilised meat Slurry is immediately fed to a minimal capacity buffer tank that continually feeds the Slurry at the optimal rate to any suitable commercial Spray Dryer that operates at an inlet temperature of about 200 deg C. which can vary dependent on the throughput of material and the water content such that the evaporation latent heat keeps the slurry droplets at a relatively low temperature below the denaturation point at the early stages of drying

16) Whole Fish Products and Methods for Producing, Stabilising and Using them as in claim 15. in which the Spray Drying throughput is speeded up and the exit temperature experienced by the product is lower by using a fluidised bed dryer at the later stage of drying to achieve the target water content 5% in the dry product with minimal denaturation and maximum throughput of dry Powder.

17) Whole Fish Products and Methods for Producing, Stabilising and Using them as in claim 1. in which the Residue components are the key elements that contributes to the structure of the final cooked Product as it contains structural materials such as denatured meat fibre and pieces of skin and bones which together with the solubilised material forms a composite structure that is “meat like” when cooked.

18) Whole Fish Products and Methods for Producing, Stabilising and Using them as in claim 17. in which the residue components comprise the structural element to accomplish the above requirement and the meat and skin, produces a fibrous element and bones that are not too finely divided as to lose structural contribution for other Products such as the Analogues and semi Analogues described below.

19) Whole Fish Products and Methods for Producing, Stabilising and Using them as in claim 18. in which the residual meat, skin and bones, are subjected to a controlled grinding and drying regime such as may be found in hygienic commercial fish meal plants or preferably uses commercial continuous twin screw extruders that grind, compress and shear the material into finely divided suitably sized particles while generating sufficient heat to soften tough material and bones and to remove some of the moisture before it enters the Drying stage.

20) Whole Fish Products and Methods for Producing, Stabilising and Using them as in claim 19. in which oxygen is eliminated by any suitable means and includes using a superheated steam drum dryer and in which the time the Fish oil is heated is shortened such that deterioration of the oil is minimised thus preventing rancid flavours while retaining a fish flavour and additionally it preferably uses an Oxygen free Steam Deodorisation Fluidised Bed Process operating at 160-200 deg C. that removes unwanted odours in the oil.

21) Whole Fish Products and Methods for Producing, Stabilising and Using them as in claim 1. in which the dry components including the oils in the right proportions for a whole fish product are first Reconstituted by first soaking the residue component in the total required amount of preferably hot water to make a whole fish product and when cooled sufficiently it is mixed with the solubilised meat component to make a dough.

22) Whole Fish Products and Methods for Producing, Stabilising and Using them as in claim 21. in which the dough produced is processed to orientate the structural component by any known system including extrusion through fine orifices or any other suitable orienting equipment by aligning the structural material while shaping it, the product assumes a more meat-like mouth-feel when cooked and eaten.

23) Whole Fish Products and Methods for Producing, Stabilising and Using them as in claim 22. in which hot water is preferred at this stage to ensure that the oil present in the dry residue does not interfere with the rehydration process before it is emulsified by the soluble meat component and the solubilised Meat Slurry of the Invention can be used in its original slurry pre-dried state to make fresh products which can also be frozen and in this mode the liquid solubilised product which comprises the cementing and emulsifying component can be mixed with the wet residue including any additional water or any other Suitable food Material that can provide the structural component in the fabrication of meat analogues and semi-analogues and the wet residue is preferably heated to soften the skin and bones and any oil exuded is re-incorporated and emulsified by the soluble meat which is essential for a good mouth feel when the product is eaten.

24) Whole Fish Products and Methods for Producing, Stabilising and Using them as in claim 23. in which in all cases, the dough is extruded through fine orifices or any other suitable orienting system, to align the structural material to produce a oriented product which can be shaped into any desirable form and which when they are cooked has the organoleptic properties and mouth-feel of meat . . . .

25) Whole Fish Products and Methods for Producing, Stabilising and Using them as in claim 24. in which large pieces of Fish Meats are made into one whole piece by actually creating a structural entity similar to animal muscle meat in which the myofibrils are aligned in one direction and the whole structure is held together by the Binder that is attached to the connective tissue material and which when cooked holds the denatured myofibrils together to produce a larger structure that has the organoleptic properties and mouth-feel of meat.

26) Whole Fish Products and Methods for Producing, Stabilising and Using them as in claim 25. in which the Products are heated, up to 50-60 deg C. and the cementing component start to irreversibly gel and which enables the product to be handled and as the product progressively hardens as the temperature rises above 60 deg C. denaturation reaches its maximum and the cooked product becomes meat like with excellent organoleptic properties.

27) Whole Fish Products and Methods for Producing, Stabilising and Using them as in claim 1. in which the fresh and dried products are packaged by any commercial means and in the Fresh/Frozen option, the oriented and shaped mixture comprising the Binder and the wet structural component including wet Mycoprotein (see below) are quick frozen or heated to 50-60 deg C. to gel it and all Products are packed as commercially done and in the Dried version the Two type of Powders comprising the Binder and the structural component (including Myco proteins) are packed separately preferably in a twin pack that is made of material that is moisture and oxygen impermeable, in the form of a bubble pack under an inert gas atmosphere or vacuum packed.

28) Whole Fish Products and Methods for Producing, Stabilising and Using them as in claim 1. in which the product range is further extended by using any type of Animal Connective tissue to create a cooked structural entity similar to animal muscle meat by mixing the Reconstituted Binder together with the Connective tissue material and aligning the fibers to give the product the organoleptic properties and mouth-feel of meat.

29) Whole Fish Products and Methods for Producing, Stabilising and Using them as in claim 28. in which other preferred types of Suitable Food Material comprise the residue contain connective tissue from the defatting of minced animal fats or trimmed connective tissue or a vegetable derived filamentous material whose filaments are of sufficient length comprising the Mycelia derived from higher Fungi such as the edible Mushroom Polyporus Squamosus (PS64) or any other approved suitable Mycoprotein with suitably long Mycelia which will comprise the structural component.

30) Whole Fish Products and Methods for Producing, Stabilising and Using them as in claim 29. in which the Mycoprotein filaments that have high protein content compared to cereals is able in combination with Fish, to boost the available world protein resource and would also be considered suitable for vegetarians and in contrast to the lower fungi such as Fusarium that is used for making Quorn that contains a high level of RNA and which has to be reduced by heating for use as a food ingredient, whereas the higher Fungi such as edible mushrooms has a sufficiently low RNA level without further treatment.

31) Whole Fish Products and Methods for Producing, Stabilising and Using them as in claim 30. which in Fresh/Frozen Fish products the combinations include mixing the solubilised liquid material and the processed Residue before the drying stage or mixing the solubilised liquid material with any other suitable structural food material, and for Dried Fish mixtures, the liquid solubilised material and the residue are first dried sufficiently to ensure long life and have to be reconstituted to its original form with water and then mixed before use, and with Mycoprotein, this component can optionally be first dried for long life and has to be suitably reconstituted with water before mixing with the liquid or spray dried reconstituted Meat binder.

32) Whole Fish Products and Methods for Producing, Stabilising and Using them as in claim 31. in which it is an essential aim of the invention to take the pre-rigor technology further than at present by applying the technology to any type of pre-rigor or post-rigor animal muscle meat or fish meats by actually creating a structural entity similar to whole animal and fish muscle meat which uses the very high Myosin content of the binder to ensure that any oils (some pelagic fish have high oil content) present in the both the solubilised material and the structural residues are strongly emulsified during the mixing process and which together results in excellent heat gelling and binding properties and minimal cooking losses and excellent organoleptic properties and mouth-feel.

33) Whole Fish Products and Methods for Producing, Stabilising and Using them as in claim 32, in which the Solubilised Muscle Protein is also preferably applied as a Slurry and as concentrated as possible and in some cases the Powdered form may be sprinkled on to the meat pieces in the mixer allowing the residual liquid on the surfaces to dissolve the Powder creating the strongest possible binding power and on forming the resultant mass into products and allowing the product to rest for a while while the high salt concentration in the binder, is slowly depleted by diffusion into the meat particles causing the gel to become unstable and set into a stiff mass and it can be further strengthened by heating the product to just over 40 degrees C. to gel it well before full denaturation occurs at cooking temperatures.

34) Whole Fish Products and Methods for Producing, Stabilising and Using them as in claim 33. in which if larger muscles are used it is essential that the muscles are oriented in one direction in the Product since when denaturation occurs on cooking, the fibres shrink along their length and if they are not properly aligned in the product they will tear apart causing breakup of the structure and in the case of land animals where there is more connective tissue present that shrink to a greater extent than the muscles, the connective is preferably disrupted by mechanical means, using tenderisers with thin sharp knives instead of needles aligned to create a multitude of cuts in the tissue which is eventually sealed back by mixing the muscles with the binder material.

35) Whole Fish Products and methods for Producing, Stabilising and Using them substantially as described in any of the above claims and in the Text and which in no way limits the Invention and the applications herewith described.
